(19) United States
(12) Patent Application Publication
(10) Pub. No.: US 2026/0353106 A1
(43) Pub. Date: Nov. 5, 2026

(54) METHOD PERFORMED BY CONTROL APPARATUS AND METHOD PERFORMED BY RU APPARATUS

(71) Applicant: NEC Corporation, Minato-ku, Tokyo (JP)

(72) Inventors: Atsushi NAKATA, Tokyo (JP); Ukyo HISHI, Tokyo (JP); Peng SHAO, Tokyo (JP)

(73) Assignee: NEC Corporation, Minato-ku, Tokyo (JP)

(21) Appl. No.: 19/105,070

(22) PCT Filed: Aug. 4, 2023
(86) PCT No.: PCT/JP2023/028610

§ 371 Date: Feb. 20, 2025

(30) Foreign Application Priority Data
Sep. 22, 2022 (JP) 2022-151205

(51) Int. Cl. H04W 24/02; H04W 52/02; H04W 76/20; H04W 76/30

(52) U.S. Cl. CPC H04W 24/02; H04W 52/0261; H04W 76/20; H04W 76/30

(57) ABSTRACT

A first control apparatus transmits, to an RU apparatus, a first request message that is based on a NETCONF protocol and indicates configuration edit. The first request message includes destination information of a second control apparatus that controls (monitors) the RU apparatus instead of the first control apparatus. The first control apparatus transmits, to the RU apparatus, a Session Close message for closing a session between the RU apparatus and the first control apparatus. The RU apparatus disconnects the session between the RU apparatus and the first control apparatus in response to reception of the Session Close message. The RU apparatus starts a procedure of establishing a session between the RU apparatus and the second control apparatus with the second control apparatus based on the destination information of the second control apparatus.

### TECHNICAL FIELD

The present disclosure relates to a control apparatus, an RU apparatus, a system, and a method.

### BACKGROUND ART

In recent years, a radio access network has been used in which a baseband unit and a radio unit of a base station are separated and the baseband unit and the radio unit are connected via a front hole. The open-radio access network (O-RAN) fronthaul specification defined by the O-RAN Alliance defines the specification of a fronthaul between an O-RAN radio unit (O-RU) corresponding to the radio unit and an O-RAN distributed unit (O-DU) corresponding to the baseband unit. One object of the O-RAN fronthaul specification is to facilitate connection with an O-RU of a vendor different from a vendor of an O-DU, and to realize multi-vendor of a radio access network. Note that the O-DU may also be simply referred to as a DU. The O-RU may also be simply referred to as an RU.

Non Patent Literature 1 defines a specification related to a management (M)-Plane defined for transmitting management data between an O-RU and an O-DU. The M-Plane provides a management function for the O-RU. In the M-Plane, the O-DU or a service management and orchestration (SMO) is defined as an apparatus that manages the O-RU. The O-RU being a management target corresponds to a NETCONF server, and an apparatus (RU control apparatus) that manages (controls) the O-RU corresponds to a NETCONF client. The M-Plane supports a protocol stack in which a signal used in a network configuration protocol (NETCONF) is transmitted in Ethernet/IP/TCP (Transmission Control Protocol)/SSH (Secure SHell) and, optionally, Ethernet/IP/TCP (Transmission Control Protocol)/TLS (Transport Layer Security) (see, for example, sections 9.1.2 and 9.1.3 of Non Patent Literature 1).

For example, Non Patent Literature 1 discloses a modification in a Power State of the O-RU. In a case where the Power State is AWAKE, the O-RU performs a normal operation (operation that is not in an energy saving mode), and in a case where the Power State is SLEEPING, the O-RU operates in the energy saving mode. The Power State of the O-RU is modified by the RU control apparatus transmitting a remote procedure call (RPC) message indicating an edit-config to the O-RU.

### CITATION LIST

### Non Patent Literature

Non Patent Literature 1: O-RAN-WG4.MP.0-v09.00, “O-RAN Working Group 4 (Open Fronthaul Interfaces WG) Management Plane Specification”

### SUMMARY OF INVENTION

### Technical Problem

The inventor has studied the O-RAN fronthaul specification and found various problems. For example, Non Patent Literature 1 does not sufficiently consider a situation in which it is desired to switch an entity that manages (controls) the O-RU and what type of processing is to be performed in this situation. For example, even though the mode of the RU apparatus transitions to an energy saving(ES) mode, the M-plane of the RU apparatus may operate (be provided). As a result, the O-RU can be in a normal mode, not in the ES mode, at any time. In a case where the mode of the RU apparatus transitions to the ES mode in an M-plane operation state (that is, a state where the M-plane is provided) if the control apparatus of the O-DU apparatus controls the RU apparatus, the control apparatus of the O-DU apparatus needs to perform vital monitoring on the RU apparatus through the M-plane. Therefore, even though the mode of the RU apparatus transitions to the ES mode, it is not possible to release the resources of the O-DU apparatus. Therefore, there is a need to switch the entity that monitors the O-DU apparatus from the control apparatus of the O-DU apparatus to another apparatus.

An object of example embodiments disclosed in the present specification is to provide a control apparatus and an RU apparatus that contribute to solving at least one of a plurality of problems including the problems described above.

Further, the object is merely one of a plurality of objects to be achieved by a plurality of example embodiments disclosed herein. The other objects or problems and novel features will be apparent from the description of the present specification or the accompanying drawings.

### Solution to Problem

According to an aspect, a first control apparatus that controls a radio unit (RU) apparatus includes
at least one memory, and
at least one processor coupled to the at least one memory.

The at least one processor is configured to,
in a case where a control entity that controls the RU apparatus is switched, transmit, to the RU apparatus, a remote procedure call (RPC) message including destination information of a second control apparatus that controls the RU apparatus instead of the first control apparatus, the RPC message being a message that is based on a network configuration protocol (NETCONF) protocol and indicates configuration edit (edit-config), and
transmit, to the RU apparatus, a Session Close message for closing a session between the RU apparatus and the first control apparatus.

According to another aspect, a radio unit (RU) apparatus includes
at least one memory, and
at least one processor coupled to the at least one memory.

The at least one processor is configured to,
in a case where a control entity that controls the RU apparatus is switched, receive, from a first control apparatus, a remote procedure call (RPC) message including destination information of a second control apparatus that controls the RU apparatus instead of the first control apparatus, the RPC message being a message that is based on a network configuration protocol (NETCONF) protocol and indicates configuration edit (edit-config),
receive, from the first control apparatus, a Session Close message for closing a session between the RU apparatus and the first control apparatus,
disconnect the session between the RU apparatus and the first control apparatus in response to reception of the Session Close message, and
start a procedure (Call home procedure) of establishing a session between the second control apparatus and the RU apparatus based on the destination information with the second control apparatus.

According to still another aspect, a second control apparatus that controls a radio unit (RU) apparatus includes
at least one memory, and
at least one processor coupled to the at least one memory.

The at least one processor is configured to start a procedure of establishing a session between the RU apparatus and the second control apparatus with the RU apparatus in a case where an entity that controls the RU apparatus is switched from the first control apparatus to the second control apparatus, and
switch an account of the second control apparatus to an account of a type in which session monitoring is permitted.

According to still yet another aspect, a method performed by a first control apparatus that controls a radio unit (RU) apparatus includes,
in a case where a control entity that controls the RU apparatus is switched, transmitting, to the RU apparatus, a remote procedure call (RPC) message including destination information of a second control apparatus that controls the RU apparatus instead of the first control apparatus, the RPC message being a message that is based on a Network Configuration Protocol (NETCONF) protocol and indicates configuration edit (edit-config), and
transmitting, to the RU apparatus, a Session Close message for closing a session between the RU apparatus and the first control apparatus.

According to still yet another aspect, a method performed by a radio unit (RU) apparatus includes,
in a case where a control entity that controls the RU apparatus is switched, receiving, from a first control apparatus, a remote procedure call (RPC) message including destination information of a second control apparatus that controls the RU apparatus instead of the first control apparatus, the RPC message being a message that is based on a network configuration protocol (NETCONF) protocol and indicates configuration edit (edit-config),
receiving, from the first control apparatus, a Session Close message for closing a session between the RU apparatus and the first control apparatus,
disconnecting the session between the RU apparatus and the first control apparatus in response to reception of the Session Close message, and
starting a procedure (Call home procedure) of establishing a session between the second control apparatus and the RU apparatus based on the destination information with the second control apparatus.

According to still yet another aspect, a method performed by a second control apparatus that controls a radio unit (RU) apparatus includes
starting, with the RU apparatus, a procedure of establishing a session between the RU apparatus and the second control apparatus in a case where an entity that controls the RU apparatus is switched from a first control apparatus to the second control apparatus, and
switching an account of the second control apparatus to an account of a type in which session monitoring is permitted.

According to still yet another aspect, a system includes
a radio unit (RU) apparatus,
a first control apparatus that controls the RU apparatus, and
a second control apparatus that controls the RU apparatus instead of the first control apparatus.

The first control apparatus is configured to,
in a case where a control entity that controls the RU apparatus is switched, transmit, to the RU apparatus, a remote procedure call (RPC) message including destination information of the second control apparatus, the RPC message being a message that is based on a network configuration protocol (NETCONF) protocol and indicates configuration edit (edit-config), and
transmit, to the RU apparatus, a Session Close message for closing a session between the RU apparatus and the first control apparatus.

The RU apparatus is configured to
receive the RPC message indicating the configuration edit from the first control apparatus,
receive the Session Close message from the first control apparatus,
disconnect the session between the RU apparatus and the first control apparatus in response to reception of the Session Close message, and
start a procedure (Call home procedure) of establishing a session between the second control apparatus and the RU apparatus based on the destination information with the second control apparatus.

### Advantageous Effects of Invention

The present disclosure can provide a control apparatus, an RU apparatus, a system, and a method that contribute to solving at least one of a plurality of problems including the above-described problems.

### BRIEF DESCRIPTION OF DRAWINGS

FIG. 1 is a diagram illustrating an example of a retrieval procedure of a State of an RU.

FIG. 2 is a diagram illustrating an example of a modification procedure of the State of the RU.

FIG. 3 is a diagram for explaining a Power State of the RU.

FIG. 4 is a diagram illustrating possible transitions and a combination of an “active” parameter and a “state” parameter.

FIG. 5 is a block diagram illustrating an example of a system in the present disclosure.

FIG. 6 is a diagram illustrating an example of a processing operation of the system in the present disclosure.

FIG. 7 is a diagram illustrating a first modified example of the processing operation of the system in the present disclosure.

FIG. 8 is a diagram illustrating a second modified example of the processing operation of the system in the present disclosure.

FIG. 9 is a diagram illustrating an example of a configuration of the control apparatus.

FIG. 10 is a diagram illustrating an example of a configuration of a DU apparatus.

FIG. 11 is a diagram illustrating an example of a configuration of the RU apparatus.

FIG. 12 is a diagram illustrating an example of a configuration of an SMO apparatus.

### EXAMPLE EMBODIMENT

Hereinafter, example embodiments will be described with reference to the drawings. Note that, in the present disclosure, the drawings can be associated with one or more example embodiments. In addition, each element of the drawings can be applied to one or more example embodiments. In addition, in the example embodiments, the same or equivalent elements are denoted by the same reference signs, and repeated description will be omitted.

A plurality of example embodiments described below can be implemented independently or can be implemented in appropriate combination. The plurality of example embodiments have novel features different from each other. Thus, the plurality of example embodiments contribute to solving different objects or problems, and contribute to exhibiting different effects.

The example embodiments described below will be described by using, the main targets, an RU apparatus and a control apparatus according to an O-RAN technical specification. However, these example embodiments may be applied to other systems that support technologies similar to these RU apparatuses and control apparatuses.

As used in the present specification, depending on the context, “if” may be interpreted to mean “when”, “at or around the time”, “after”, “upon”, “in response to determining”, “in accordance with a determination”, or “in response to detecting” These expressions may be interpreted to have the same meaning depending on the context.

First, the related art will be described. The individual example embodiments are based on these technologies. In other words, these technologies may be incorporated into individual example embodiments.

### Protocol

A control (C)-Plane is a protocol for transferring a control signal. A user (U)-Plane is a protocol for transferring user data. The C/U-Plane supports a protocol stack in which a signal used in eCPRI or radio over Ethernet (RoE) is directly transmitted by Ethernet and a protocol stack in which a signal is optionally transmitted via a user datagram protocol (UDP)/IP.

A synchronization (S)-Plane is a protocol for realizing synchronization between apparatuses. The S-Plane supports a protocol stack in which a signal used in a precision time protocol (PTP) and synchronous Ethernet (SyncE) is transmitted by Ethernet.

A management (M)-Plane is a protocol for handling a maintenance monitoring signal. The M-Plane supports a protocol stack in which a signal used in a network configuration protocol (NETCONF) is transmitted in Ethernet/IP/TCP (Transmission Control Protocol)/SSH (Secure SHell) and, optionally, Ethernet/IP/TCP (Transmission Control Protocol)/TLS (Transport Layer Security).

### Logical Architecture

The open-radio access network (O-RAN) alliance adopts a configuration in which a communication processing function of a RAN can be separated into three components of a radio unit (RU), a distributed unit (DU), and a central unit (CU). In addition, a “RAN intelligent controller (RIC)” which is a platform for realizing optimization of radio resource management and automation of operation, and a “service management and orchestration (SMO)” as a framework for performing maintenance and orchestration of the RAN are defined.

The RU and the DU are connected by an open fronthaul. A CUS/M-Plane signal is transmitted by the open fronthaul between the RU and the DU. Note that the RU and the SMO may be connected by the open fronthaul, and an M-Plane signal may be transmitted by the open fronthaul. Even in this case, the CUS-Plane signal is transmitted through the open fronthaul between the RU and the DU.

In addition, the DU and the SMO are connected by an Ol interface. In addition, the CU and the SMO are also connected by the Ol interface.

The RU being a management target corresponds to a NETCONF server, and a device (RU control apparatus) that manages (controls) the RU corresponds to a NETCONF client. The NETCONF client may be disposed in the DU, or may be disposed in the SMO.

### Retrieval of State of RU

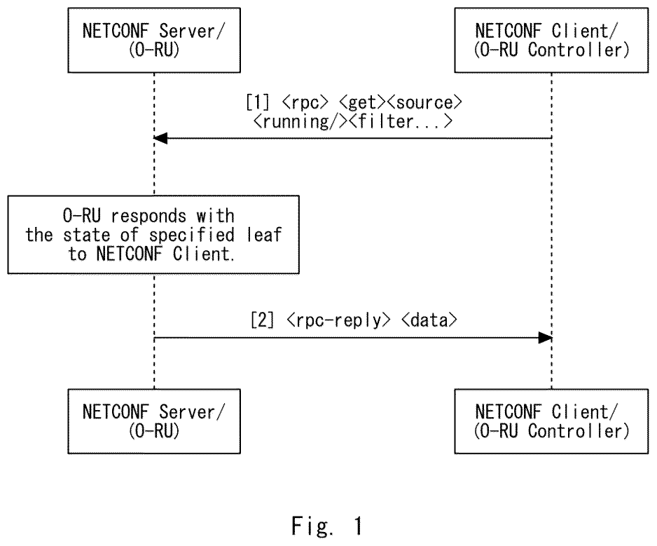

FIG. 1 is a diagram illustrating an example of a retrieval procedure of a State of an RU. In FIG. 1, an RU control apparatus (RU Controller) retrieves the state of the RU by using a NETCONF<get> procedure.

Specifically, the RU control apparatus transmits a remote procedure call (RPC) message indicating retrieval (get) to the RU. The RU transmits an RPC reply (rpc-reply) message to the RU controller in response to the RPC message. The RPC reply message includes information indicating the State of the RU. That is, the RU control apparatus can retrieve the State of the RU by a <get> request.

### Modification of State of RU

The RU control apparatus may modify a configurable State of an RU that supports optional (selectable) hardware-state features defined in hardware of the RU. The RU control apparatus can modify the configurable State of the RU by using a NETCONF<edit-config> procedure without reset.

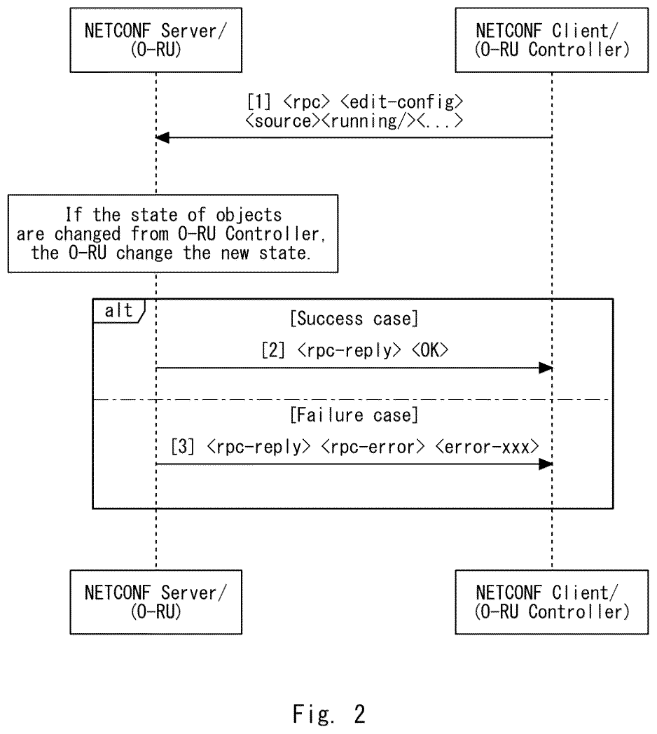

FIG. 2 is a diagram illustrating an example of the modification procedure of the State of the RU. The RU control apparatus modifies the configurable State of the RU by using the NETCONF<edit-config> procedure without reset.

Specifically, the RU control apparatus transmits, to the RU, an RPC message indicating configuration edit (edit-config). The RU modifies the own state based on this RPC message. Then, in a case where the modification is successful, the RU transmits an RPC reply message indicating <OK> to the RU control apparatus.

### Power-State

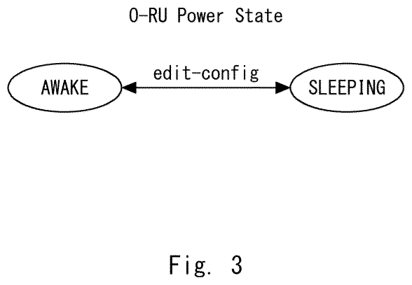

The configurable State of the RU is, for example, a power-state. As illustrated in FIG. 3, the Power State of the RU includes “AWAKE” and “SLEEPING”. FIG. 3 is a diagram for explaining the Power State of the RU.

The RU control apparatus controls the Power State of the RU by transmitting an RPC message indicating configuration edit (edit-config) to the RU to edit an “energy-saving-enabled” parameter of the RU. That is, by setting the value of a configurable parameter of “energy-saving-enabled” to TRUE or FALSE, the value of a non-Configurable parameter of the Power-state is transitioned to AWAKE or SLEEPING.
AWAKE: This Power State indicates that the RU is in normal operation, that is, is not in an Energy saving mode.
SLEEPING: This Power State indicates that the RU is in the Energy saving mode.

### Carrier Configuration of RU

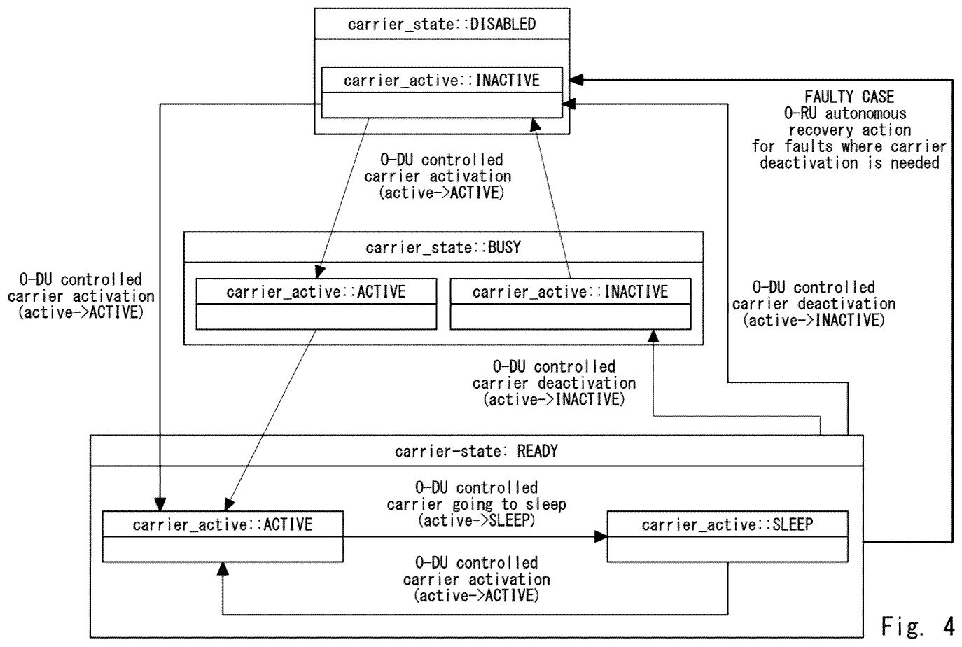

The RU control apparatus can set (update) the parameters of the RU by using the NETCONF<edit-config> procedure. For example, the RU control apparatus performs activation by setting the value of an “active” parameter for a tx-array-carrier(s) element (and/or rx-array-carrier(s) element) to “ACTIVE”. In addition, the RU control apparatus performs deactivation by setting the value of the “active” parameter for the tx-array-carrier(s) element (and/or rx-array-carrier(s) element) to “INACTIVE”. In addition, the RU control apparatus sets the tx-array-carrier(s) element (and/or rx-array-carrier(s) element) to sleep by setting the value of the “active” parameter for the tx-array-carrier(s) element (and/or rx-array-carrier(s) element) to “SLEEP”. The tx-array-carrier(s) element (and/or rx-array-carrier(s) element) is in a sleep mode in a case where the value of the “active” parameter is “SLEEP” and the value of a “State” parameter is “READY”. FIG. 4 is a diagram illustrating possible transitions and a combination of the “active” parameter and the “state” parameter.

Here, the tx-array-carrier(s) is a data node that is generated by the RU control apparatus and includes a carrier configuration parameter, and is associated with transmission array (tx-array) information of the RU. In addition, the rx-array-carrier(s) is a data node that is generated by the RU control apparatus and includes a carrier configuration parameter, and is associated with reception array (rx-array) information of the RU. The tx-array-carrier(s) and the rx-array-carrier(s) are generated for each carrier and for each transmission/reception array, and the center frequency, the bandwidth, the transmission power, and the like of the carrier with respect to the RU are set.

### First Example Embodiment

### Example of Configuration of System

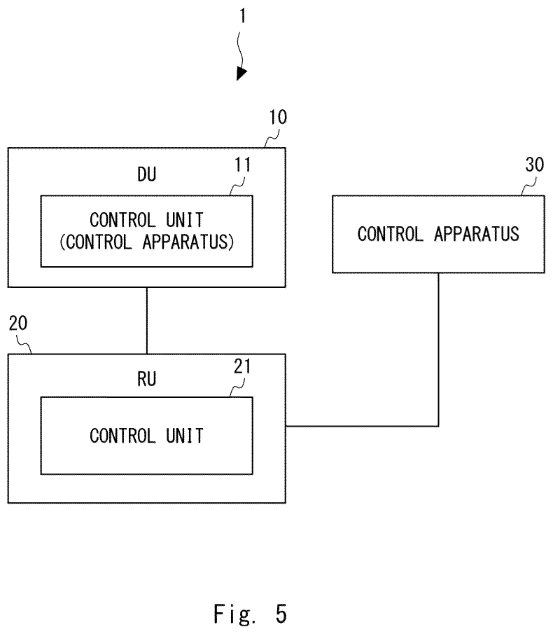

FIG. 5 is a block diagram illustrating an example of a system in the present disclosure. In FIG. 5, a system 1 includes a DU apparatus 10, an RU apparatus 20, and a control apparatus 30.

The DU apparatus 10 may be a logical node that executes functions in a packet data convergence protocol (PDCP) layer, a radio link control (RLC) layer, and a media access control (MAC) layer, and further a higher function of a physical layer, or may be a physical device on which the logical node is mounted. The higher function of the physical layer may be, for example, encoding and modulation processing, decoding and demodulation processing, and the like. The function in the PDCP layer may be executed in a logical node referred to as a central unit (CU) (not illustrated).

The RU apparatus 20 may be a logical node that executes a lower function (PHY-Low) of the physical layer and radio frequency (RF) processing, or may be a physical device on which the logical node is mounted. The lower function of the physical layer may be, for example, fast Fourier transform (FFT)/inverse FFT (IFFT) processing, beam forming (BF) processing, and the like.

In FIG. 5, the DU apparatus 10 includes a control unit (control apparatus) 11. The control unit (control apparatus) 11 corresponds to a NETCONF client.

The control unit (control apparatus) 11 may be referred to as a “first control apparatus” below. The RU apparatus 20 includes a control unit 21. The RU apparatus 20 itself or the control unit 21 may correspond to a NETCONF server. The DU apparatus 10 and the RU apparatus 20 are connected via an open fronthaul. The open fronthaul can transmit a CUS-Plane signal and an M-Plane signal.

Here, there is a need to switch a control entity that controls (monitors) the RU apparatus 20 from the control apparatus 11 to the control apparatus 30. The control apparatus 30 may be referred to as a “second control apparatus” below.

As described above, for example, in a case where the control apparatus 11 of the DU apparatus 10 controls the RU apparatus 20, the mode of the RU apparatus 20 may transition to the ES mode in the M-plane operation state (that is, state where the M-plane is provided). At this time, unless the control entity that controls the RU apparatus 20 is switched, the control apparatus 11 of the DU apparatus 10 needs to perform vital monitoring of the RU apparatus 20 through the M-plane.

Therefore, even though the mode of the RU apparatus 20 transitions to the ES mode, it is not possible to release the resources of the DU apparatus 10. Thus, the resource of the DU apparatus 10 can be released by switching the control entity that controls the RU apparatus 20 from the control apparatus 11 to the control apparatus 30.

The control apparatus 30 may be, for example, a control unit (RU control apparatus) of the SMO apparatus. The control unit (RU control apparatus) of the SMO apparatus may correspond to a NETCONF client. The SMO apparatus performs maintenance and orchestration of a radio access network (RAN) and a RAN intelligent controller (RIC) which is a platform for realizing optimization of radio resource management and automation of operation. At this time, the RU apparatus 20 and the SMO apparatus may also be connected by an open fronthaul. In addition, the DU apparatus 10 and the SMO apparatus may be connected via an O1 interface.

In addition, the control apparatus 30 may be, for example, a control unit (control apparatus) of a DU apparatus other than the DU apparatus 10. The control unit (control apparatus) of another DU apparatus may correspond to a NETCONF client. The RU apparatus 20 and another DU apparatus may also be connected by an open fronthaul. Note that another DU apparatus may be connected to the RU apparatus 20 and connected to another RU apparatus. The mode of this other RU apparatus may be the normal mode or the ES mode.

Furthermore, the control apparatus 30 may be, for example, an event collector disclosed in Non Patent Literature 1.

In addition, the control apparatus 30 may be, for example, a dedicated device that controls (monitors) the RU apparatus.

Note that, in the energy saving(ES) mode of the RU apparatus 20, the power-state of the RU apparatus 20 is SLEEPING, and the value of the active parameter of tx/rx-array-carriers of the RU apparatus 20 is SLEEP or INACTIVE, or both (that is, the power-state of the RU apparatus 20 is SLEEPING, and the value of the active parameter of tx/rx-array-carriers of the RU apparatus 20 is SLEEP or INACTIVE).

### Examples of Operations of System

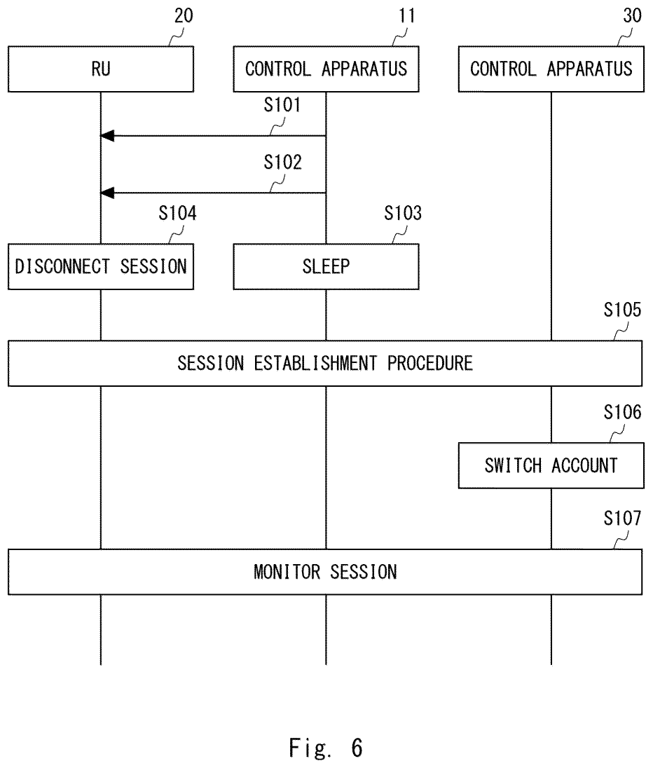

FIG. 6 is a diagram illustrating an example of a processing operation of the system in the present disclosure. The processing operation of the system 1 illustrated in FIG. 6 is started in a case where the control entity that controls (monitors) the RU apparatus 20 is switched from the control apparatus 11 to the control apparatus 30.

The control apparatus 11 transmits a message (may be referred to as a “first request message” below) indicating configuration edit (edit-config), to the RU apparatus 20 (step S101). The first request message may be based on a network configuration protocol (NETCONF) protocol. The first request message includes destination information of the control apparatus 30 that controls (monitors) the RU apparatus 20 instead of the control apparatus 11. As a result, it is possible to add the destination of the control apparatus 30 to the information element which is related to the destination and is held by the RU apparatus 20.

The control apparatus 11 transmits, to the RU apparatus 20, a Session Close message (for example, a close-session command. That is, an RPC message including a <close-session> operation) for closing a session between the RU apparatus 20 and the control apparatus 11 (step S102). Then, the control apparatus 11 transitions the DU apparatus 10 to the sleep state (step S103). As a result, it is possible to realize energy saving of the DU apparatus 10. In addition, as described above, energy saving of the RU apparatus 20 is also realized by the ES mode. Therefore, when a base station (for example, a next generation nodeB (gNB)) is configured by the RU apparatus 20 and the DU apparatus 10, it is possible to realize energy saving of the base station.

The RU apparatus 20 disconnects the session between the RU apparatus 20 and the control apparatus 11 in response to reception of the Session Close message (step S104).

The RU apparatus 20 starts a procedure of establishing a session between the RU apparatus 20 and the control apparatus 30 with the control apparatus 30 based on the destination information of the control apparatus 30 (step S105).

This procedure may be, for example, a Call home procedure defined in the O-RAN (see, for example, Section 6.3 of Non Patent Literature 1). With this procedure, it is possible to establish an M-plane between the RU apparatus 20 and the control apparatus 30 and switch the control entity that controls (monitors) the RU apparatus 20 to the control apparatus 30.

The control apparatus 30 switches the account of control apparatus 30 to the account of a type in which session monitoring is permitted (step S106). The account of the type in which the session monitoring is permitted may be, for example, a Root account or an O-DU account, or may be an account dedicated to session monitoring (Supervision account).

The control apparatus 30 and the RU apparatus 20 mutually monitor the session via the M-plane (step S107). For example, the RU apparatus 20 may transmit a notification signal indicating that the RU apparatus 20 exists (the RU apparatus 20 is alive), to the control apparatus 30. In addition, the control apparatus 30 may transmit a notification signal indicating that the control apparatus 30 exists, to the RU apparatus 20. As a result, bidirectional session monitoring is performed by the control apparatus 30 and the RU apparatus 20. These notification signals may be referred to as heartbeats, for example. In addition, such session monitoring may be based on Monitoring NETCONF Connectivity defined in the O-RAN (see, for example, Section 6.7 of Non Patent Literature 1).

For example, in a case where the control apparatus 30 corresponds to a NETCONF client and the RU apparatus 20 corresponds to a NETCONF server, the notification signal transmitted to the control apparatus 30 by the RU apparatus 20 may be Supervision-notification. In addition, the notification signal transmitted to the RU apparatus 20 by the control apparatus 30 may be an RPC message indicating <Supervision-Watchdog-reset>. At this time, the RU apparatus 20 may use two timers (Notification timer and Supervision timer) called Watchdog timers. The Notification timer is set to Notification-timer-interval. The Supervision timer is set to Notification-timer-interval+guard-timer-overhead.

The RU apparatus 20 transmits Supervision-notification to the control apparatus 30 in a case where the Notification timer has expired. In response to reception of the Supervision-notification, the control apparatus 30 transmits an RPC message indicating <Supervision-Watchdog-reset> to the RU apparatus 20. The RU apparatus 20 resets the Notification timer and the Supervision timer. Note that a case where the control apparatus 30 corresponds to a NETCONF client is, for example, a case where the control apparatus 30 is a control unit (RU control apparatus) of an SMO apparatus or a case where the control apparatus 30 is a control unit (control apparatus) of a DU apparatus other than the DU apparatus 10, as described above.

Note that the control entity that controls (monitors) the RU apparatus 20 may be brought back from the control apparatus 30 to the control apparatus 11 by a procedure similar to the procedure illustrated in FIG. 6. Specifically, the control apparatus 30 transmits, to the RU apparatus 20, a first request message including destination information of the control apparatus 11 that controls (monitors) the RU apparatus 20 instead of the control apparatus 30. In addition, the control apparatus 30 transmits, to the RU apparatus 20, a Session Close message for closing a session between the RU apparatus 20 and the control apparatus 30. The RU apparatus 20 disconnects the session between the RU apparatus 20 and the control apparatus 30 in response to reception of the Session Close message. The RU apparatus 20 starts a procedure of establishing a session between the RU apparatus 20 and the control apparatus 11 with the control apparatus 11 based on the destination information of the control apparatus 30.

### Modified Example

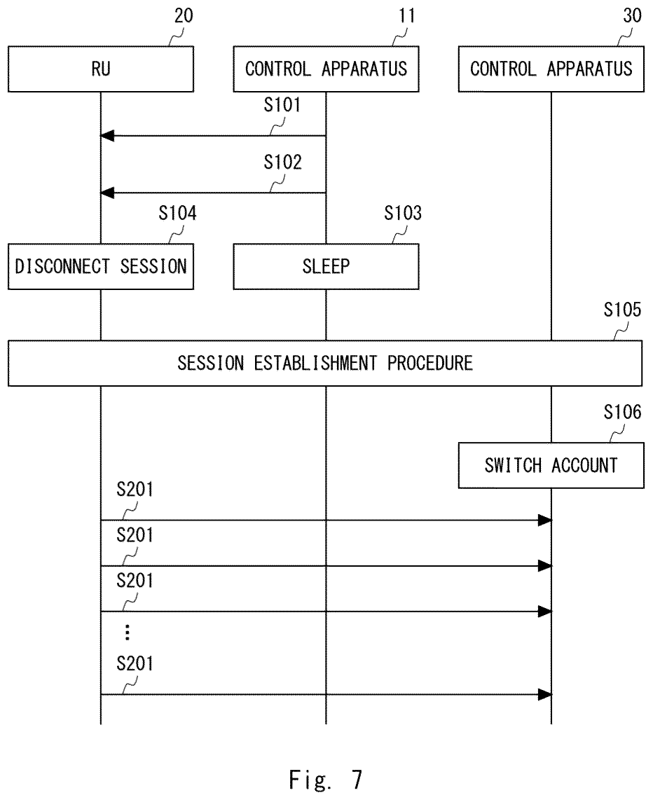

The processing operation of the system in the first example embodiment may be modified as follows.
<1> FIG. 7 is a diagram illustrating a first modified example of the processing operation of the system in the present disclosure. As illustrated in FIG. 7, the RU apparatus 20 periodically transmits a notification signal (for example, Supervision notification, heartbeat, and the like) indicating that the RU apparatus 20 exists, to the control apparatus 30 (step S201). On the other hand, the control apparatus 30 does not transmit a notification signal (for example, Supervision notification, heartbeat, and the like) indicating that the control apparatus 30 exists, to the RU apparatus 20. That is, the control apparatus 30 does not transmit the notification signal indicating that the control apparatus 30 exists, to the RU apparatus 20, and receives the notification signal indicating that the RU apparatus 20 exists, from the RU apparatus 20. As a result, instead of bidirectional session monitoring, the control apparatus 30 monitors the state of the RU apparatus 20 (for example, the vital of the RU apparatus 20) in one direction. As a result, it is possible to simplify the monitoring method. Note that, in particular, in a case where the control apparatus 30 is an event collector, the notification signal received from the RU apparatus 20 by the control apparatus 30 may be Heartbeat-Notification.

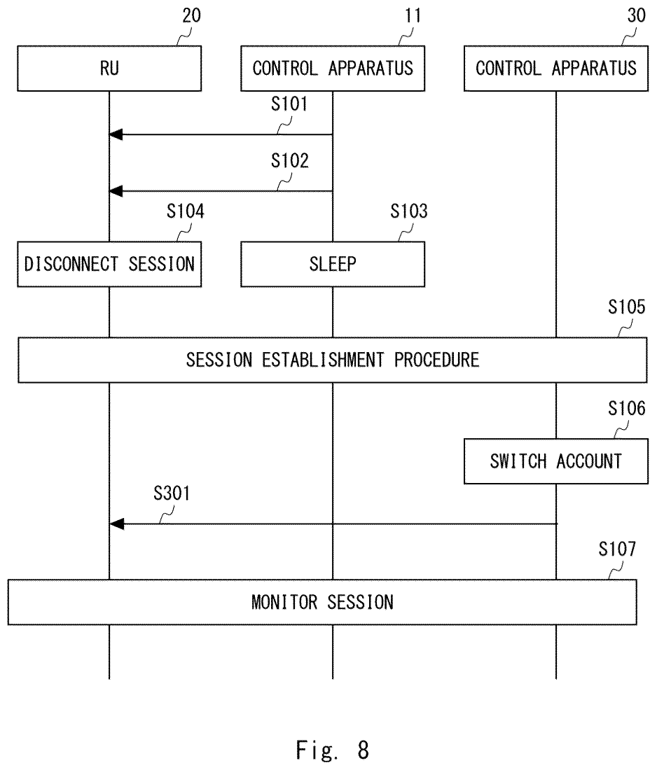

As described above, in a case where the control apparatus 30 is a control unit (control apparatus) of a DU apparatus other than the DU apparatus 10, the control apparatus 30 may be connected to the RU apparatus 20 and connected to another RU apparatus. The mode of this other RU apparatus may be the normal mode or the ES mode. In a case where the mode of the other RU apparatus is the normal mode, the control apparatus 30 may perform bidirectional session monitoring with the other RU apparatus.
<2> FIG. 8 is a diagram illustrating a second modified example of the processing operation of the system in the present disclosure. As illustrated in FIG. 8, the control apparatus 30 transmits, to the RU apparatus 20, a message including information for changing a cycle (transmission interval) in which the RU apparatus 20 transmits a notification signal (for example, Supervision notification, heartbeat, and the like) indicating that the RU apparatus 20 exists (step S301). The control apparatus 30 may transmit the message including information for changing the cycle immediately after establishing an M-plane between the RU apparatus 20 and the control apparatus 30. In addition, the control apparatus 30 may change the transmission cycle of the RU apparatus 20 to a cycle according to the load of the control apparatus 30. For example, the control apparatus 30 may increase the transmission cycle of the RU apparatus 20 as the load of the control apparatus 30 increases (that is, as the margin of the processing capability of the control apparatus 30 becomes smaller). Note that the message including the information for changing the cycle (transmission interval) transmitted by the RU apparatus 20 may also be transmitted from the control apparatus 30 to the RU apparatus 20 in the sequence of FIG. 7.

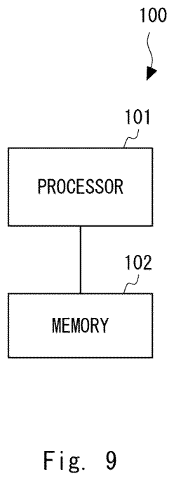

### Other Example Embodiments

<1> FIG. 9 is a diagram illustrating an example of the configuration of the control apparatus. In FIG. 9, a control apparatus 100 includes a processor 101 and a memory 102. The control apparatuses 11 and 30 may have a configuration illustrated in FIG. 9. The processor 101 may be, for example, a microprocessor, a micro processing unit (MPU), or a central processing unit (CPU). The processor 101 may include a plurality of processors. The memory 102 is configured by a combination of a volatile memory and a nonvolatile memory. The memory 102 may include a plurality of physically independent memory devices. The volatile memory is, for example, a Static Random Access Memory (SRAM), a Dynamic RAM (DRAM), or a combination thereof. The non-volatile memory is a masked Read Only Memory (MROM), an Electrically Erasable Programmable ROM (EEPROM), a flash memory, or a hard disk drive, or any combination thereof. The memory 102 may include a storage located away from the processor 101. In this case, the processor 101 may access the memory 102 through an input (I)/output (O) interface (not illustrated).

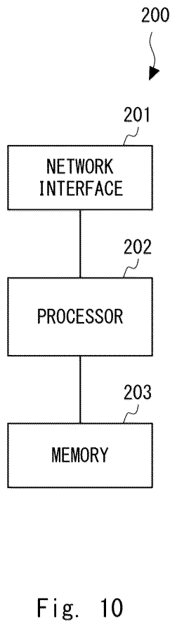

The memory 102 may store one or more software module (computer program) including a group of instructions and data for performing processing by the control apparatus 11 or 30 described in the example embodiments as described above. In some implementations, the processor 101 may be configured to perform the processing of the control apparatus 11 or 30 described in the example embodiments as described above by reading and executing the software module from the memory 102.
<2> FIG. 10 is a diagram illustrating a configuration example of the DU apparatus. In FIG. 10, an apparatus 200 includes a network interface 201, a processor 202, and a memory 203. The DU apparatus 10 and the above other DU apparatus may have a configuration illustrated in FIG. 10.

The network interface 201 is used, for example, to communicate with a network element (for example, the SMO apparatus 30, and other RAN nodes). The network interface 1201 may include, for example, a network interface card (NIC) conforming to IEEE 802.3 series.

The processor 202 may be, for example, a microprocessor, an MPU, or a CPU. The processor 202 may include a plurality of processors.

The memory 203 is constituted by a volatile memory and a nonvolatile memory. The memory 203 may include a plurality of physically independent memory devices. The volatile memory is, for example, a Static Random Access Memory (SRAM), a Dynamic RAM (DRAM), or a combination thereof. The non-volatile memory is a masked Read Only Memory (MROM), an Electrically Erasable Programmable ROM (EEPROM), a flash memory, or a hard disk drive, or any combination thereof. The memory 203 may include a storage located away from the processor 202. In this case, the processor 202 may access the memory 203 through the network interface 201 or an I/O interface.

The memory 203 may store one or more software module (computer program) including a group of instructions and data for performing processing by the DU apparatus 10 and the above other DU apparatus described in the example embodiments as described above. In some implementations, the processor 202 may be configured to perform the processing of the DU apparatus 10 and the above other DU apparatus described in the example embodiments as described above by reading and executing the software module from the memory 203.

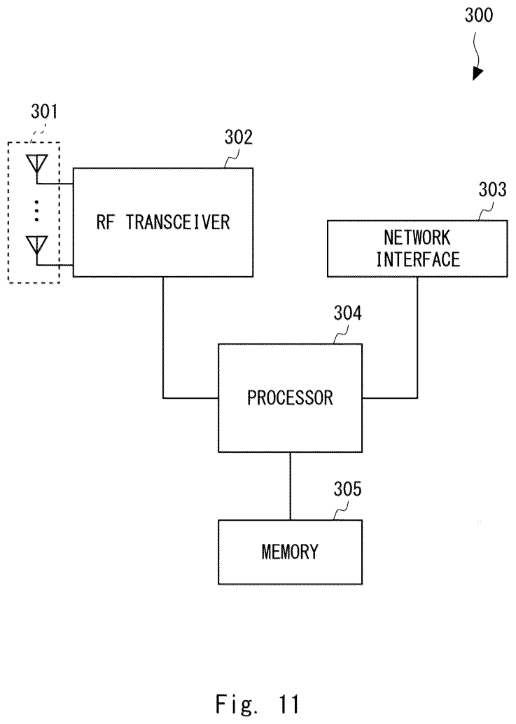

Note that a dedicated apparatus that controls (monitors) the above event collector and the RU apparatus may also have the configuration illustrated in FIG. 10.
<3> FIG. 11 is a diagram illustrating a configuration example of the RU apparatus. In FIG. 11, an apparatus 300 includes an antenna array 301, a radio frequency transceiver 302, a network interface 303, a processor 304, and a memory 305. The RU apparatus 20 may have a configuration illustrated in FIG. 11. The RF transceiver 302 performs analog RF signal processing to communicate with UEs. The RF transceiver 302 may include a plurality of transceivers. The RF transceiver 302 is coupled with the antenna array 301 and the processor 304. The RF transceiver 302 receives modulation symbol data from the processor 304, generates a transmission RF signal, and provides the transmission RF signal to the antenna array 301. Also, the RF transceiver 302 generates a baseband reception signal based on a reception RF signal received by the antenna array 301, and provides the baseband reception signal to the processor 304. The RF transceiver 302 may include an analog beam former circuit for beam forming. The analog beam former circuit includes, for example, a plurality of phase shifters and a plurality of power amplifiers.

The network interface 303 is used to communicate with a network node (for example, the DU 10 and the SMO 30). The network interface 303 may include, for example, a network interface card (NIC) conforming to IEEE 802.3 series.

The processor 304 performs digital baseband signal processing (data plane processing) for radio communication and control plane processing. The processor 304 may include a plurality of processors. For example, the processor 304 may include a modem processor (for example, a digital signal processor (DSP)) that performs digital baseband signal processing and a protocol stack processor (for example, a central processing unit (CPU) or a micro processing unit (MPU)) that performs control plane processing.

The processor 304 may include a digital beam former module for beam forming. The digital beam former module may include a multiple input multiple output (MIMO) encoder and a precoder.

The memory 305 is constituted by a combination of a volatile memory and a nonvolatile memory. The volatile memory is, for example, a Static Random Access Memory (SRAM), a Dynamic RAM (DRAM), or a combination thereof. The non-volatile memory is a masked Read Only Memory (MROM), an Electrically Erasable Programmable ROM (EEPROM), a flash memory, or a hard disk drive, or any combination thereof. The memory 305 may include a storage disposed away from the processor 304. In this case, the processor 304 may access the memory 305 through the network interface 303 or an I/O interface (not illustrated).

The memory 305 may store one or more software module (computer program) including a group of instructions and data for performing processing by the RU apparatus 20 described in the example embodiments as described above. In some implementations, the processor 304 may be configured to perform the processing of the RU apparatus 20 described in the example embodiments as described above by reading and executing the software module from the memory 305.

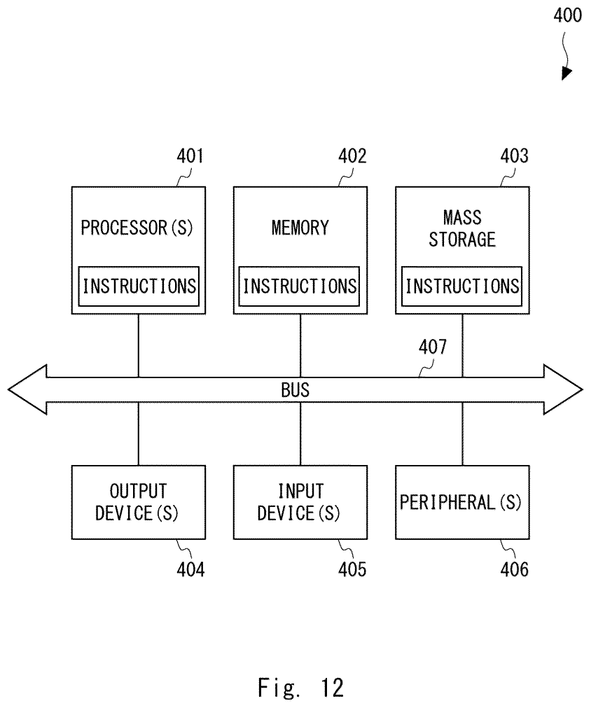

The antenna array 301 may correspond to the above-described tx-array and rx-array.
<4> FIG. 12 is a diagram illustrating a configuration example of the SMO apparatus. In the example of FIG. 12, an SMO apparatus 400 is implemented as a computer system. The computer system 400 includes one or more processors 401, a memory 402, and a mass storage 403, which communicate with each other via a bus 407. The one or more processors 401 may include, for example, a central processing unit (CPU) or a graphics processing unit (GPU) or both the CPU and the GPU. The computer system 400 may include other devices, such as one or more output devices 404, one or more input devices 405, and one or more peripherals 406. The one or more peripherals 406 may include a modem, a network adapter, or any combination thereof.

One or both of the memory 402 and the mass storage 403 include a computer-readable medium storing one or more instruction sets. These instructions may be disposed partially or entirely in a memory within one or more processors 401. In a case where these instructions are executed in the one or more processors 401, these instructions cause the one or more processors 401 to provide the functions of the SMO apparatus 30 described in the above example embodiments.

Note that a dedicated apparatus that controls (monitors) the above event collector and the RU apparatus may also have the configuration illustrated in FIG. 12.

Although the present disclosure has been described above with reference to the example embodiments, the present disclosure is not limited to the above. Various modifications that could be understood by those skilled in the art may be made to the configuration and details of the present disclosure within the scope of the disclosure. Each example embodiment can be appropriately combined with another example embodiment.

Some or all of the above-described example embodiments may be described as in the following Supplementary Notes, but are not limited to the following Supplementary Notes.

### Supplementary Note 1

A first control apparatus that controls a radio unit (RU) apparatus, the first control apparatus including:
at least one memory; and
at least one processor coupled to the at least one memory,
in which the at least one processor is configured to
in a case where a control entity that controls the RU apparatus is switched,
transmit, to the RU apparatus, a remote procedure call (RPC) message including destination information of a second control apparatus that controls the RU apparatus instead of the first control apparatus, the RPC message being a message that is based on a network configuration protocol (NETCONF) protocol and indicates configuration edit (edit-config), and
transmit, to the RU apparatus, a Session Close message for closing a session between the RU apparatus and the first control apparatus.

### Supplementary Note 2

The first control apparatus according to Supplementary Note 1, in which
the case where the control entity that controls the RU apparatus is switched includes a case where a mode of the RU apparatus transitions to an energy saving(ES) mode.

### Supplementary Note 3

The first control apparatus according to Supplementary Note 2, in which in the ES mode of the RU apparatus, a management (M)-plane of the RU apparatus operates.

### Supplementary Note 4

The first control apparatus according to Supplementary Note 2 or 3, in which in the ES mode of the RU apparatus, one or both of a case where a power-state of the RU apparatus is SLEEPING, or a case where a value of an active parameter of tx/rx-array-carriers of the RU apparatus is SLEEP or INACTIVE occur.

### Supplementary Note 5

A radio unit (RU) apparatus including:
at least one processor coupled to the at least one memory,
in which the at least one processor is configured to
in a case where a control entity that controls the RU apparatus is switched,
receive, from a first control apparatus, a remote procedure call (RPC) message including destination information of a second control apparatus that controls the RU apparatus instead of the first control apparatus, the RPC message being a message that is based on a network configuration protocol (NETCONF) protocol and indicates configuration edit (edit-config),
receive, from the first control apparatus, a Session Close message for closing a session between the RU apparatus and the first control apparatus,
disconnect the session between the RU apparatus and the first control apparatus in response to reception of the Session Close message, and
start a procedure (Call home procedure) of establishing a session between the second control apparatus and the RU apparatus based on the destination information with the second control apparatus.

### Supplementary Note 6

The RU apparatus according to Supplementary Note 5, in which the case where the control entity that controls the RU apparatus is switched includes a case where a mode of the RU apparatus transitions to an energy saving(ES) mode.

### Supplementary Note 7

The RU apparatus according to Supplementary Note 6, in which in an energy saving(ES) mode of the RU apparatus, the at least one processor operates a management (M)-plane of the RU apparatus.

### Supplementary Note 8

The RU apparatus according to Supplementary Note 6 or 7, in which in the energy saving(ES) mode of the RU apparatus, one or both of a case where a power-state of the RU apparatus is SLEEPING, and a case where a value of an active parameter of tx/rx-array-carriers of the RU apparatus is SLEEP or INACTIVE occur.

### Supplementary Note 9

The RU apparatus according to any one of Supplementary Notes 5 to 7, in which after establishing the session between the RU apparatus and the second control apparatus, the at least one processor transmits, to the second control apparatus, a notification signal indicating that the RU apparatus exists.

### Supplementary Note 10

A second control apparatus that controls a radio unit (RU) apparatus, the second control apparatus including:
at least one memory; and
at least one processor coupled to the at least one memory,
in which the at least one processor is configured to
start a procedure of establishing a session between the RU apparatus and the second control apparatus with the RU apparatus in a case where an entity that controls the RU apparatus is switched from the first control apparatus to the second control apparatus, and
switch an account of the second control apparatus to an account of a type in which session monitoring is permitted.

### Supplementary Note 11

The second control apparatus according to Supplementary Note 10, in which the case where the entity that controls the RU apparatus is switched from the first control apparatus to the second control apparatus includes a case where a mode of the RU apparatus transitions to an energy saving(ES) mode.

### Supplementary Note 12

The second control apparatus according to Supplementary Note 11, in which in the ES mode of the RU apparatus, a management (M)-plane of the RU apparatus operates.

### Supplementary Note 13

The second control apparatus according to Supplementary Note 11 or 12, in which in the ES mode of the RU apparatus, one or both of a case where a power-state of the RU apparatus is SLEEPING, or a case where a value of an active parameter of tx/rx-array-carriers of the RU apparatus is SLEEP or INACTIVE occur.

### Supplementary Note 14

The second control apparatus according to any one of Supplementary Notes 10 to 12, in which the at least one processor transmits, to the RU apparatus, a message including information for changing a transmission interval at which the RU apparatus transmits, to the second control apparatus, a notification signal indicating that the RU apparatus exists.

### Supplementary Note 15

The second control apparatus according to any one of Supplementary Notes 10 to 12, in which the at least one processor does not transmit, to the RU apparatus, a notification signal indicating that the second control apparatus exists, and receives, from the RU apparatus, a notification signal indicating that the RU apparatus exists.

### Supplementary Note 16

The second control apparatus according to any one of Supplementary Notes 10 to 12, in which the second control apparatus is a distributed unit (DU) node, a service management and orchestration (SMO) node, or an event collector.

### Supplementary Note 17

A method performed by a first control apparatus that controls a radio unit (RU) apparatus, the method including:
in a case where a control entity that controls the RU apparatus is switched,
transmitting, to the RU apparatus, a remote procedure call (RPC) message including destination information of a second control apparatus that controls the RU apparatus instead of the first control apparatus, the RPC message being a message that is based on a Network Configuration Protocol (NETCONF) protocol and indicates configuration edit (edit-config); and
transmitting, to the RU apparatus, a Session Close message for closing a session between the RU apparatus and the first control apparatus.

### Supplementary Note 18

The method according to Supplementary Note 17, in which the case where the control entity that controls the RU apparatus is switched includes a case where a mode of the RU apparatus transitions to an energy saving(ES) mode.

### Supplementary Note 19

A method performed by a radio unit (RU) apparatus, the method including:
in a case where a control entity that controls the RU apparatus is switched,
receiving, from a first control apparatus, a remote procedure call (RPC) message including destination information of a second control apparatus that controls the RU apparatus instead of the first control apparatus, the RPC message being a message that is based on a network configuration protocol (NETCONF) protocol and indicates configuration edit (edit-config);
receiving, from the first control apparatus, a Session Close message for closing a session between the RU apparatus and the first control apparatus;
disconnecting the session between the RU apparatus and the first control apparatus in response to reception of the Session Close message; and
starting a procedure (Call home procedure) of establishing a session between the second control apparatus and the RU apparatus based on the destination information with the second control apparatus.

### Supplementary Note 20

The method according to Supplementary Note 19, in which the case where the control entity that controls the RU apparatus is switched includes a case where a mode of the RU apparatus transitions to an energy saving(ES) mode.

### Supplementary Note 21

A method performed by a second control apparatus that controls a radio unit (RU) apparatus, the method including:
starting, with the RU apparatus, a procedure of establishing a session between the RU apparatus and the second control apparatus in a case where an entity that controls the RU apparatus is switched from a first control apparatus to the second control apparatus; and
switching an account of the second control apparatus to an account of a type in which session monitoring is permitted.

### Supplementary Note 22

The method according to Supplementary Note 21, in which the case where the entity that controls the RU apparatus is switched from the first control apparatus to the second control apparatus includes a case where a mode of the RU apparatus transitions to an energy saving(ES) mode.

### Supplementary Note 23

A system including:
a radio unit (RU) apparatus;
a first control apparatus that controls the RU apparatus; and
a second control apparatus that controls the RU apparatus instead of the first control apparatus, in which
the first control apparatus is configured to
in a case where a control entity that controls the RU apparatus is switched,
transmit, to the RU apparatus, a remote procedure call (RPC) message including destination information of the second control apparatus, the RPC message being a message that is based on a network configuration protocol (NETCONF) protocol and indicates configuration edit (edit-config), and
transmit, to the RU apparatus, a Session Close message for closing a session between the RU apparatus and the first control apparatus, and
the RU apparatus is configured to
receive the RPC message indicating the configuration edit from the first control apparatus,
receive the Session Close message from the first control apparatus,
disconnect the session between the RU apparatus and the first control apparatus in response to reception of the Session Close message, and
start a procedure (Call home procedure) of establishing a session between the second control apparatus and the RU apparatus based on the destination information with the second control apparatus.

### Supplementary Note 24

The system according to Supplementary Note 23,
in which the second control apparatus is configured to
start the procedure of establishing the session with the RU, and
switch an account of the second control apparatus to an account of a type in which session monitoring is permitted.

This application claims priority based on Japanese Patent Application No. 2022-151205 filed on Sep. 22, 2022, the entire disclosure of which is incorporated herein.

### REFERENCE SIGNS LIST

10 DU APPARATUS
11 CONTROL UNIT (FIRST CONTROL APPARATUS)
20 RU APPARATUS
21 CONTROL UNIT
30 CONTROL APPARATUS (SECOND CONTROL APPARATUS)

What is claimed is:

1-24. (canceled)

25. A method performed by a first control apparatus that controls a radio unit (RU) apparatus, the method comprising:
in a case where a control entity that controls the RU apparatus is switched,
transmitting, to the RU apparatus, a remote procedure call (RPC) message including destination information of a second control apparatus that controls the RU apparatus instead of the first control apparatus, the RPC message being a message that is based on a Network Configuration Protocol (NETCONF) protocol and indicates configuration edit (edit-config); and
transmitting, to the RU apparatus, a Session Close message for closing a session between the RU apparatus and the first control apparatus.

26. The method according to claim 25, wherein the case where the control entity that controls the RU apparatus is switched includes a case where a mode of the RU apparatus transitions to an energy saving(ES) mode.

27. The method according to claim 26, wherein in the ES mode of the RU apparatus, a management (M)-plane of the RU apparatus operates.

28. The method according to claim 26, wherein in the ES mode of the RU apparatus, one or both of a case where a power-state of the RU apparatus is SLEEPING, or a case where a value of an active parameter of tx/rx-array-carriers of the RU apparatus is SLEEP or INACTIVE occur.

29. A method performed by a radio unit (RU) apparatus, the method comprising:
in a case where a control entity that controls the RU apparatus is switched,
receiving, from a first control apparatus, a remote procedure call (RPC) message including destination information of a second control apparatus that controls the RU apparatus instead of the first control apparatus, the RPC message being a message that is based on a network configuration protocol (NETCONF) protocol and indicates configuration edit (edit-config);
receiving, from the first control apparatus, a Session Close message for closing a session between the RU apparatus and the first control apparatus;
disconnecting the session between the RU apparatus and the first control apparatus in response to reception of the Session Close message; and
starting a procedure (Call home procedure) of establishing a session between the second control apparatus and the RU apparatus based on the destination information with the second control apparatus.

30. The method according to claim 29, wherein the case where the control entity that controls the RU apparatus is switched includes a case where a mode of the RU apparatus transitions to an energy saving(ES) mode.

31. The method according to claim 30, wherein in an energy saving(ES) mode of the RU apparatus, a management (M)-plane of the RU apparatus operates.

32. The method according to claim 30, wherein in the energy saving(ES) mode of the RU apparatus, one or both of a case where a power-state of the RU apparatus is SLEEPING, and a case where a value of an active parameter of tx/rx-array-carriers of the RU apparatus is SLEEP or INACTIVE occur.

33. The method according to claim 29, the method further comprising: transmitting, after establishing the session between the RU apparatus and the second control apparatus, to the second control apparatus, a notification signal indicating that the RU apparatus exists.

34. A method performed by a second control apparatus that controls a radio unit (RU) apparatus, the method comprising:
starting, with the RU apparatus, a procedure of establishing a session between the RU apparatus and the second control apparatus in a case where an entity that controls the RU apparatus is switched from a first control apparatus to the second control apparatus; and
switching an account of the second control apparatus to an account of a type in which session monitoring is permitted.

35. The method according to claim 34, wherein the case where the entity that controls the RU apparatus is switched from the first control apparatus to the second control apparatus includes a case where a mode of the RU apparatus transitions to an energy saving(ES) mode.

36. The method according to claim 35, wherein in the ES mode of the RU apparatus, a management (M)-plane of the RU apparatus operates.

37. The method according to claim 35, wherein in the ES mode of the RU apparatus, one or both of a case where a power-state of the RU apparatus is SLEEPING, or a case where a value of an active parameter of tx/rx-array-carriers of the RU apparatus is SLEEP or INACTIVE occur.

38. The method according to claim 34, the method further comprising: transmitting, to the RU apparatus, a message including information for changing a transmission interval at which the RU apparatus transmits, to the second control apparatus, a notification signal indicating that the RU apparatus exists.

39. The method according to claim 34, wherein
a notification signal indicating that the second control apparatus exists is not transmitted to the RU apparatus, and
the method further comprises: receiving, from the RU apparatus, a notification signal indicating that the RU apparatus exists.

40. The method according to claim 34, wherein the second control apparatus is a distributed unit (DU) node, a service management and orchestration (SMO) node, or an event collector.
